(19) United States
(12) Patent Application Publication
(10) Pub. No.: US 2012/0223590 A1
(43) Pub. Date: Sep. 6, 2012

(54) REDUCING HEAT DISSIPATION IN A WIRELESS POWER RECEIVER

(75) Inventors: Zhen Ning Low, San Diego, CA (US); Kevin Douglas Lee, San Diego, CA (US); Charles Edward Wheatley, III, Del Mar, CA (US)

(73) Assignee: QUALCOMMM Incorporated, San Diego, CA (US)

(21) Appl. No.: 13/352,189

(22) Filed: Jan. 17, 2012

Related U.S. Application Data
(60) Provisional application No. 61/448,536, filed on Mar. 2, 2011.

(51) Int. Cl. H02J 17/00

(52) U.S. Cl. 307/104

(57) ABSTRACT

This disclosure provides systems, methods and apparatus for managing a temperature of a wireless power receiver. In one aspect a wireless power transmitter is provided. The wireless power transmitter includes a transmit circuit including a transmit coil. The transmit circuit is configured to wirelessly transmit power to a wireless power receiver. The wireless power transmitter further includes a communication circuit configured to receive information based on a temperature measurement of the wireless power receiver. The wireless power transmitter further includes a transmit controller circuit configured to adjust an operating point of power transfer based on the information.

### CROSS REFERENCE TO RELATED APPLICATIONS

This application claims priority under 35 U.S.C. §119(e) to U.S. Provisional Patent Application No. 61/448,536 entitled “REDUCING HEAT DISSIPATION IN WIRELESS POWER RECEIVER” filed on Mar. 2, 2011, the disclosure of which is hereby incorporated by reference in its entirety.

### FIELD

The present invention relates generally to wireless power. More specifically, the disclosure is directed to preventing over heating in a wireless power receiver.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power. As such, these devices constantly require recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY OF THE INVENTION

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power transmitter. The wireless power transmitter includes a transmit circuit comprising a transmit coil. The transmit circuit is configured to wirelessly transmit power to a wireless power receiver. The wireless power transmitter further includes a communication circuit configured to receive information based on a temperature measurement of the wireless power receiver. The wireless power transmitter further includes a transmit controller circuit configured to adjust an operating point of power transfer based on the information.

Another aspect of the disclosure provides an implementation of a method for managing a temperature level of a wireless power receiver. The method includes receiving information based on a temperature measurement of the wireless power receiver. The method further includes adjusting an operating point of power transfer based on the information.

Yet another aspect of the disclosure provides a wireless power transmitter. The wireless power transmitter includes means for wirelessly transmitting power to a wireless power receiver. The wireless power transmitter further includes means for receiving information based on a temperature measurement of the wireless power receiver. The wireless power transmitter further includes means for adjusting configured to adjust an operating point of power transfer based on the information.

Another aspect of the disclosure provides a wireless power receiver. The wireless power receiver includes a receive circuit comprising a receive coil. The receive circuit is configured to receive wireless power from a wireless power transmitter. The wireless power receiver further includes a battery unit. The wireless power receiver further includes a receive controller circuit configured to measure a temperature of the battery unit. The receive controller circuit is further configured to cause an adjustment in an operating point to maintain the temperature below a temperature threshold value.

Another aspect of the disclosure provides an implementation of a method for managing a temperature level of a wireless power receiver. The method includes measuring a temperature of a battery unit of the wireless power receiver. The method further includes adjusting an operating point to maintain the temperature below a temperature threshold.

Yet another aspect of the disclosure provides a wireless power receiver. The wireless power receiver includes means for wirelessly receiving power from a wireless power transmitter. The wireless power receiver further includes means for storing energy. The wireless power receiver further includes means for measuring a temperature of the means for storing energy. The wireless power receiver further includes means for adjusting an operating point to maintain the temperature below a temperature threshold value.

### BRIEF DESCRIPTION OF THE DRAWINGS

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive coil, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of an exemplary wireless power transmitter circuit that may be used in the transmitter of FIG. 4, in accordance with exemplary embodiments of the invention.

FIG. 7 is a functional block diagram of an exemplary wireless power system with a transmitter as in FIG. 4 and a receiver as in FIG. 5.

FIG. 8 is a plot showing transmitter and receiver power losses as a function of the voltage output by a rectifier of the receiver.

FIG. 9 is a plot showing the end-to-end efficiency of wireless power transfer system excluding transmitter overhead losses as a function of the voltage output by a rectifier in the receiver.

FIG. 10 is a plot showing the additional power loss in the transmitter as a function of the power loss reduction in the receiver.

FIG. 11 is a flowchart showing an exemplary method for managing the temperature of a wireless power receiver, in accordance with exemplary embodiments of the invention.

FIG. 12 is a flow chart of an exemplary method for managing a temperature level of a wireless power receiver, in accordance with exemplary embodiments of the invention.

FIG. 13 is a functional block diagram of a wireless power transmitter, in accordance with an exemplary embodiment of the invention.

FIG. 14 is a flow chart of an exemplary method for managing a temperature level of a wireless power receiver, in accordance with exemplary embodiments of the invention.

FIG. 15 is a functional block diagram of a wireless power receiver, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. The exemplary embodiments of the invention may be practiced without these specific details. In some instances, well-known structures and devices are shown in block diagram form in order to avoid obscuring the novelty of the exemplary embodiments presented herein.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

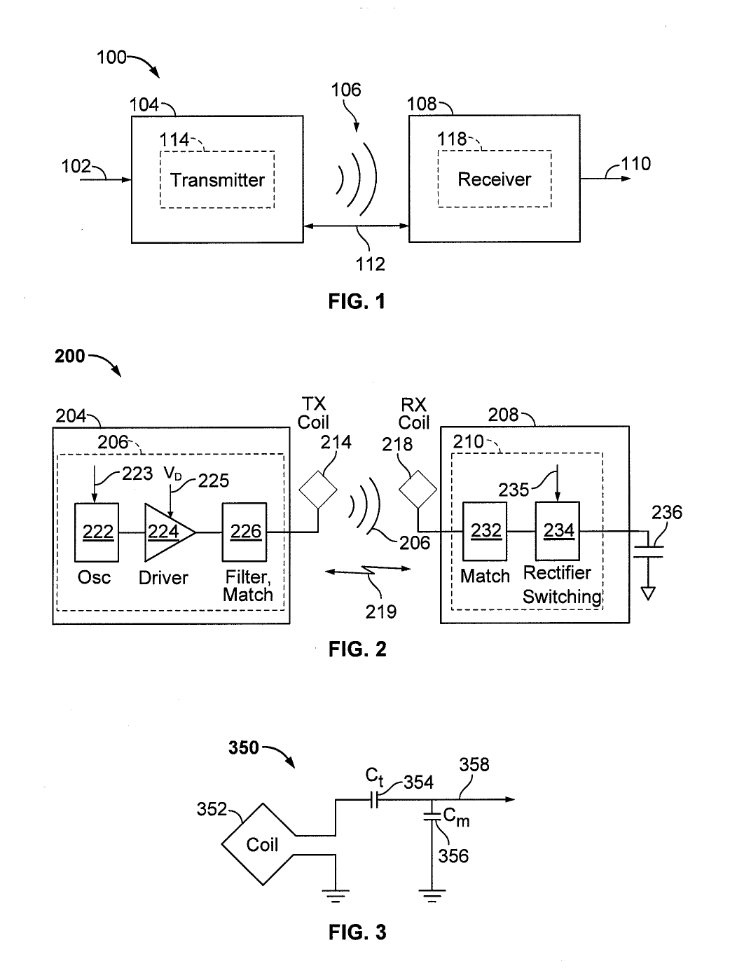

FIG. 1 is a functional block diagram of an exemplary wireless power transfer system 100, in accordance with exemplary embodiments of the invention. Input power 102 may be provided to a transmitter 104 from a power source (not shown) for generating a field 106 for providing energy transfer. A receiver 108 may couple to the field 106 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 106 produced by the transmitter 104. The field 106 corresponds to a region where energy output by the transmitter 104 may be captured by a receiver 106. In some cases, the field 106 may correspond to the “near-field” of the transmitter 104. as will be further described below. The transmitter 104 may include a transmit coil 114 for outputting an energy transmission. The receiver 108 further includes a receive coil 118 for receiving or capturing energy from the energy transmission. The near-field may correspond to a region in which there are strong reactive fields resulting from the currents and charges in the transmit coil 114 that minimally radiate power away from the transmit coil 114. In some cases the near-field may correspond to a region that is within about one wavelength (or a fraction thereof) of the transmit coil 114. The transmit and receive coils 114 and 118 are sized according to applications and devices to be associated therewith. As described above, efficient energy transfer may occur by coupling a large portion of the energy in a field 106 of the transmit coil 114 to a receive coil 118 rather than propagating most of the energy in an electromagnetic wave to the far field. When positioned within the field 106, a “coupling mode” may be developed between the transmit coil 114 and the receive coil 118. The area around the transmit and receive coils 114 and 118 where this coupling may occur is referred to herein as a coupling-mode region.

FIG. 2 is a functional block diagram of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit coil 214 at, for example, a resonant frequency of the transmit coil 214. The driver circuit 224 may be a switching amplifier configured to receive a square wave from the oscillator 22 and output a sine wave. For example, the driver circuit 224 may be a class E amplifier. A filter and matching circuit 226 may be also included to filter out harmonics or other unwanted frequencies and match the impedance of the transmitter 204 to the transmit coil 214.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive coil 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described more fully below, receiver 208, that may initially have a selectively disablable associated load (e.g., battery 236), may be configured to determine whether an amount of power transmitted by transmitter 204 and receiver by receiver 208 is appropriate for charging a battery 236. Further, receiver 208 may be configured to enable a load (e.g., battery 236) upon determining that the amount of power is appropriate. In some embodiments, a receiver 208 may be configured to directly utilize power received from a wireless power transfer field without charging of a battery 236. For example, a communication device, such as a near-field communication (NFC) or radio-frequency identification device (RFID) may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry or receive circuitry of FIG. 2 including a transmit or receive coil 352, in accordance with exemplary embodiments of the invention. As illustrated in FIG. 3, transmit or receive circuitry 350 used in exemplary embodiments may include a coil 352. The coil may also be referred to or be configured as a “loop” antenna 352. The coil 352 may also be referred to herein or configured as a “magnetic” antenna or an induction coil. The term “coil” is intended to refer to a component that may wirelessly output or receive energy for coupling to another “coil”. The coil may also be referred to as an “antenna” of a type that is configured to wirelessly output or receive power. The coil 352 may be configured to include an air core or a physical core such as a ferrite core (not shown). Air core loop coils may be more tolerable to extraneous physical devices placed in the vicinity of the core. Furthermore, an air core coil 352 allows the placement of other components within the core area. In addition, an air core loop may more readily enable placement of the receive coil 218 (FIG. 2) within a plane of the transmit coil 214 (FIG. 2) where the coupled-mode region of the transmit coil 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 106 of the transmitting coil to the receiving coil residing in the neighborhood where this field 106 is established rather than propagating the energy from the transmitting coil into free space.

The resonant frequency of the loop or magnetic coils is based on the inductance and capacitance. Inductance may be simply the inductance created by the coil 352, whereas, capacitance may be added to the coil's inductance to create a resonant structure at a desired resonant frequency. As a non-limiting example, capacitor 352 and capacitor 354 may be added to the transmit or receive circuit 350 to create a resonant circuit that selects a signal 356 at a resonant frequency. Accordingly, for larger diameter coils, the size of capacitance needed to sustain resonance may decrease as the diameter or inductance of the loop increases. Furthermore, as the diameter of the coil 352 increases, the efficient energy transfer area of the near-field may increase. Other resonant circuits formed using other components are also possible. As another non-limiting example, a capacitor may be placed in parallel between the two terminals of the coil 352. For transmit coils, a signal 358 with a frequency that substantially corresponds to the resonant frequency of the coil 352 may be an input to the coil 352.

In one embodiment, the transmitter 104 may be configured to output a time varying magnetic field with a frequency corresponding to the resonant frequency of the transmit coil 114. When the receiver is within the field 106, the time varying magnetic field may induce a current in the receive coil 118. As described above, if the receive coil 118 is configured to be resonant at the frequency of the transmit coil 118, energy may be efficiently transferred. The AC signal induced in the receive coil 118 may be rectified as described above to produce a DC signal that may be provided to charge or to power a load.

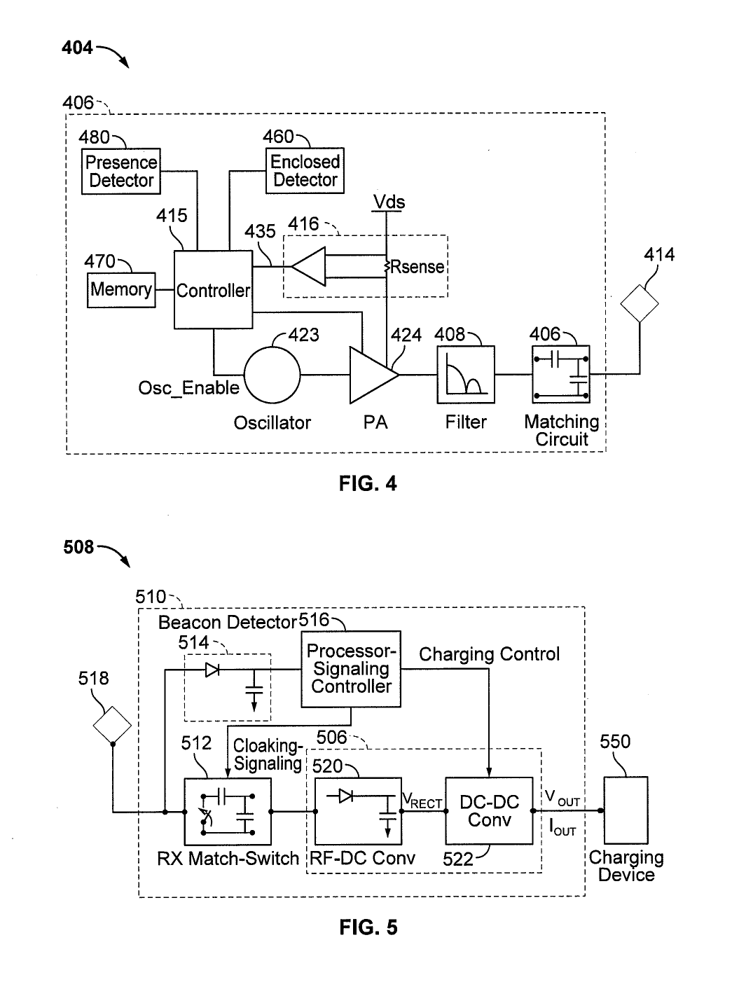

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit coil 414. The transmit coil 414 may be the coil 352 as shown in FIG. 3. Transmit circuitry 406 may provide RF power to the transmit coil 414 by providing an oscillating signal resulting in generation of energy (e.g., magnetic flux) about the transmit coil 414. Transmitter 404 may operate at any suitable frequency. By way of example, transmitter 404 may operate at the 13.56 MHz ISM band.

Transmit circuitry 406 may include a fixed impedance matching circuit 406 for matching the impedance of the transmit circuitry 406 (e.g., 50 ohms) to the transmit coil 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the coil 414 or DC current drawn by the driver circuit 424. Transmit circuitry 406 further includes a driver circuit 424 configured to drive an RF signal as determined by an oscillator 423. The transmit circuitry 406 may be comprised of discrete devices or circuits, or alternately, may be comprised of an integrated assembly. An exemplary RF power output from transmit coil 414 may be on the order of 2.5 Watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coil 404. By way of example, a load sensing circuit 416 monitors the current flowing to the driver circuit 424, that may be affected by the presence or absence of active receivers in the vicinity of the field generated by transmit coil 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the power driver 424 may be used to determine whether an invalid device is positioned within wireless power transfer region of the transmitter 404.

The transmit coil 414 may be implemented with a Litz wire or as an antenna strip with the thickness, width and metal type selected to keep resistive losses low. In one implementation, the transmit coil 414 may generally be configured for association with a larger structure such as a table, mat, lamp or other less portable configuration. Accordingly, the transmit coil 414 generally may not need “turns” in order to be of a practical dimension. An exemplary implementation of a transmit coil 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmitter circuitry 404 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit coil 414 may transmit at a specific frequency. In some cases, these regulations are meant to protect humans from electromagnetic radiation. However, there may be environments where a transmit coil 414 is placed in areas not occupied by humans, or occupied infrequently by humans, such as, for example, garages, factory floors, shops, and the like. If these environments are free from humans, it may be permissible to increase the power output of the transmit coil 414 above the normal power restrictions regulations. In other words, the controller 415 may adjust the power output of the transmit coil 414 to a regulatory level or lower in response to human presence and adjust the power output of the transmit coil 414 to a level above the regulatory level when a human is outside a regulatory distance from the electromagnetic field of the transmit coil 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive coil that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a functional block diagram of a receiver 508 that may be used in the wireless power transfer system of FIG. 1, in accordance with exemplary embodiments of the invention. The receiver 508 includes receive circuitry 510 that may include a receive coil 518. Receiver 508 further couples to device 550 for providing received power thereto. It should be noted that receiver 508 is illustrated as being external to device 550 but may be integrated into device 550. Energy may be propagated wirelessly to receive coil 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (an other medical devices), and the like.

Receive coil 518 may be tuned to resonate at the same frequency, or within a specified range of frequencies, as transmit coil 414 (FIG. 4). Receive coil 518 may be similarly dimensioned with transmit coil 414 or may be differently sized based upon the dimensions of the associated device 550. By way of example, device 550 may be a portable electronic device having diametric or length dimension smaller that the diameter of length of transmit coil 414. In such an example, receive coil 518 may be implemented as a multi-turn coil in order to reduce the capacitance value of a tuning capacitor (not shown) and increase the receive coil's impedance. By way of example, receive coil 518 may be placed around the substantial circumference of device 550 in order to maximize the coil diameter and reduce the number of loop turns (i.e., windings) of the receive coil 518 and the inter-winding capacitance.

Receive circuitry 510 may provide an impedance match to the receive coil 518. Receive circuitry 510 includes power conversion circuitry 506 for converting a received RF energy source into charging power for use by the device 550. Power conversion circuitry 506 includes an RF-to-DC converter 520 and may also in include a DC-to-DC converter 522. RF-to-DC converter 520 rectifies the RF energy signal received at receive coil 518 into a non-alternating power with an output voltage represented by V_{rect}. The DC-to-DC converter 522 (or other power regulator) converts the rectified RF energy signal into an energy potential (e.g., voltage) that is compatible with device 550 with an output voltage and output current represented by Vₒᵤₜ and Iₒᵤₜ. Various RF-to-DC converters are contemplated, including partial and full rectifiers, regulators, bridges, doublers, as well as linear and switching converters.

Receive circuitry 510 may further include switching circuitry 512 for connecting receive coil 518 to the power conversion circuitry 506 or alternatively for disconnecting the power conversion circuitry 506. Disconnecting receive coil 518 from power conversion circuitry 506 not only suspends charging of device 550, but also changes the “load” as “seen” by the transmitter 404 (FIG. 2).

As disclosed above, transmitter 404 includes load sensing circuit 416 that may detect fluctuations in the bias current provided to transmitter driver circuit 415. Accordingly, transmitter 404 has a mechanism for determining when receivers are present in the transmitter's near-field.

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 refers to a device sensing and charging control mechanism, rather than conventional two-way communication (i.e., in band signaling using the coupling field). In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive coil 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations, that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 may also occur upon the occurrence of other events including detection of an external wired charging source (e.g., wall/USB power) providing charging power to device 550. Processor 516, in addition to controlling the cloaking of the receiver, may also monitor beacon circuitry 514 to determine a beacon state and extract messages sent from the transmitter 404. Processor 516 may also adjust the DC-to-DC converter 522 for improved performance.

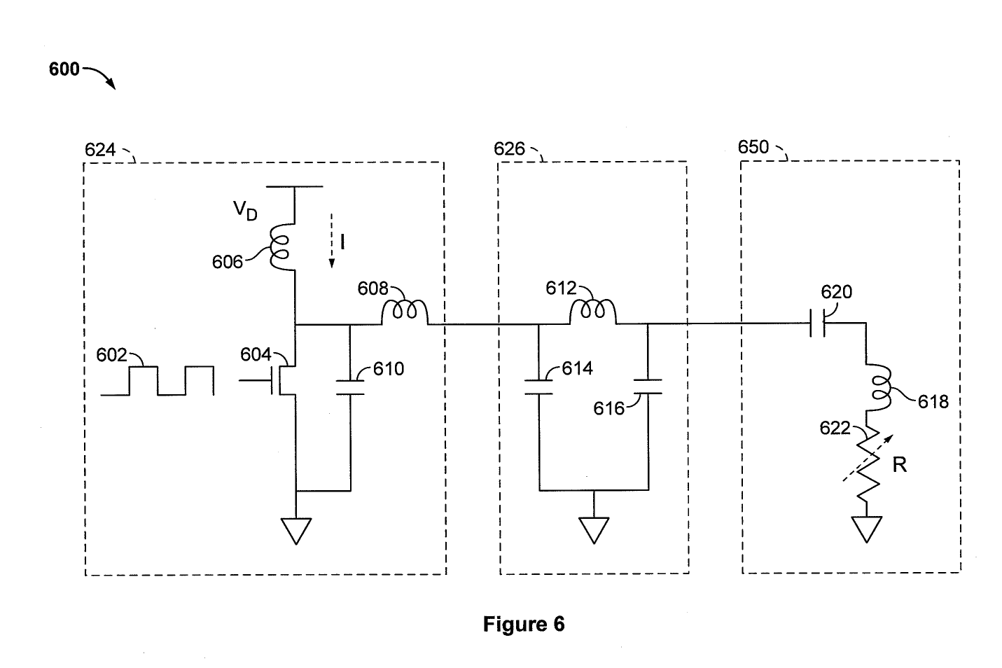

FIG. 6 is a schematic diagram of an exemplary wireless power transmit circuit 600 that may be used in the transmitter of FIG. 4. The wireless power transmit circuit 600 may include a driver circuit 624 as described above in FIG. 5. The driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 that may come from an oscillator (not shown) such as the oscillator 423 of FIG. 4. The driver circuit 624 may also be driven with a drive voltage V_{D} that is configured to control the maximum power that may be delivered through a transmit circuit 650. To eliminate or reduce harmonics, the transmit circuit 600 may include a filter circuit 626. The filter circuit 626 may be a three pole (C 614, L 612, C 616) low pass filter circuit 626.

The signal output by the filter circuit 626 may be provided to a transmit circuit 650. The transmit circuit 650 may include a series resonant circuit including a capacitance 620 and inductance 618 that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

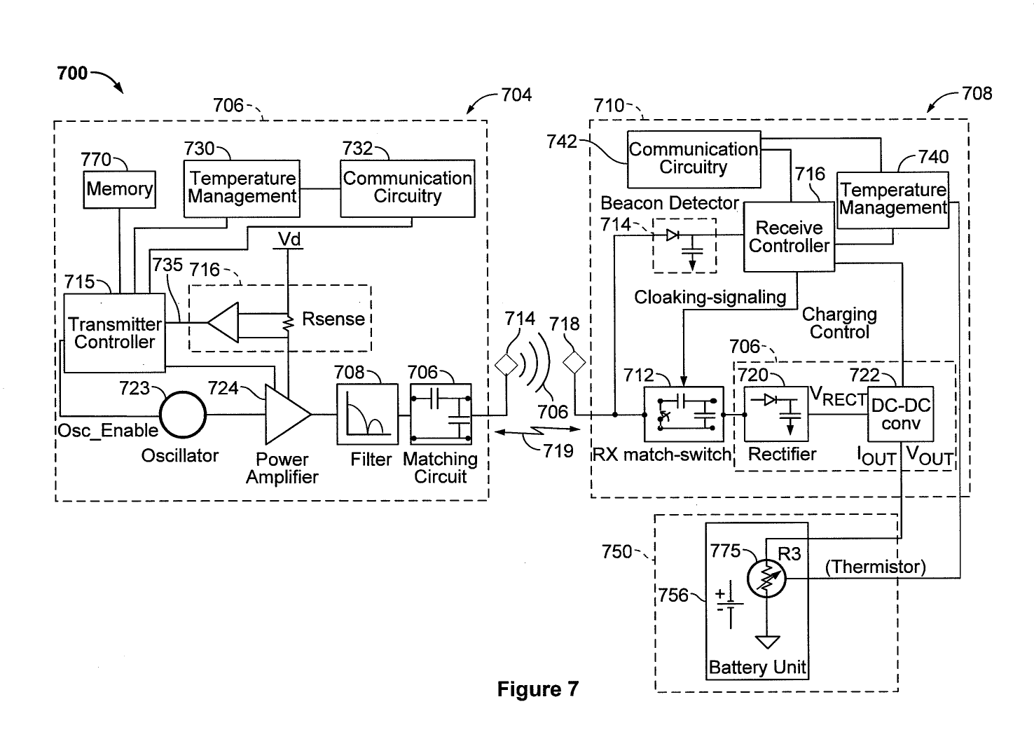

FIG. 7 is a functional block diagram of an exemplary wireless power system 700 with a transmitter as in FIG. 4 and a receiver as in FIG. 5. The receiver 708 is connected to charging device 750 including a battery unit 756 that includes a temperature sensor circuit 775. The battery unit 756 may receive a voltage based on the voltage V_{rect} at the output of a rectifier 720 for charging the battery unit 756. To manage the temperature of a receiver 708, and more specifically the battery, the battery unit 756 may include the temperature sensor circuit 775 shown as a resistor R3 that includes a thermistor that is internal to battery unit 756. The temperature sensor circuit 775 may be configured to output a value based on the temperature of the receiver 708 such as the thermistor voltage. It is noted that although the exemplary embodiments described herein include a thermistor, the embodiments of the present invention are not so limited. Rather, battery unit 756 may comprise, or may be coupled to, any suitable sensor for sensing a temperature.

The output of the temperature sensor 775 may be provided to temperature management circuitry 740 configured to derive temperature data and perform various functions based on the temperature. In some embodiments, the receive controller circuit 740, or other module may perform the functions of the temperature management circuit 740 and may receive, and interpret the temperature sensor output to derive current temperature data. Furthermore, while the temperature sensor 775 is shown in the battery unit 756, a temperature sensor 775 such as a thermistor may be included in other portions of the wireless receiver for measuring temperature of the receiver 708.

The receiver 708 may further include receiver communication circuitry 742 that may be configured to transmit data to the transmitter 704. As described above, the communication circuitry 742 may communicate via the communication link 719 (using e.g., Bluetooth, zigbee, cellular, etc.). Furthermore, communication may also be accomplished via in-band signaling as also described above. The receiver communication circuitry 742 may receive or provide information to the receiver controller 716 or the temperature management circuitry 740.

The transmitter 704 may also include temperature management circuitry 730 configured to perform functions based on information received about the temperature of the receiver 708 as will be further described below. The transmitter 704 may further include transmit communication circuitry 732 that may be configured to send information to and receive information from the receiver 708. As described above the communication circuitry 732 may communicate via the communication link 719 or using in-band signaling as described above.

The temperature of a receiver 708 may have an impact on the receiver's performance, and more particularly, the battery performance and charge time. For example, if a receiver 708 becomes overheated, charge time of the battery unit 756 may be increased. One aspect of exemplary embodiments are directed to preventing overheating of a wireless power receiver 708 while maintaining charge time when possible. More specifically, in response to detected temperature increases in the receiver 708, one aspect of an embodiment is directed to adjusting an operating point of the system 700 to reduce losses in the receiver 708 (which may increase losses in the transmitter 704) while maintaining an amount of voltage Vₒᵤₜ provided to the battery unit 750 constant. In one aspect, adjusting the operating point may correspond to one or both of the efficiency of power transfer and a power level transferred.

A wireless charging system 700 ma y be configured to maximize power transfer efficiency. However, maintaining maximum power transfer efficiency at a constant power level may result in increasing heat at a receiver 708 due in part to power losses. If the temperature of the receiver 708 increases above a threshold, the receiver 708 may be configured to take certain precautionary measures to prevent system failures or to prevent damage to system components. For example, if the receiver 708 is a mobile phone, the phone may be configured to perform thermal cycling when the phone exceeds a certain temperature in order to protect the operation of the battery. These actions may have significant power requirements that limit the power that would otherwise be used to charge a device thus reducing performance and lengthening charge times. As such, avoiding functions such as thermal cycling in response to temperature increases at a receiver 708 while also maintaining charge time may provide several benefits.

Maximum power transfer efficiency (e.g., end-to-end efficiency) between coupled transmit and receive coils 714 and 718 may occur at an optimum load impedance that may be a function of the parasitic resistance and mutual inductance of both the transmit coil 714 and the receive coil 718. In one aspect, the end-to-end efficiency may be indicated as the DC power delivered to the load of the receiver 708 divided by the DC power provided to the transmitter 704. When the load impedance is higher than the optimum amount, power losses may be reduced in the receiver 708 while being increased in the transmitter 704. Conversely, a lower than optimum load impedance may result in increasing power losses in the receiver 708 while reducing losses in the transmitter 404. A wireless power transfer system may adjust an operating point to determine where in the system (i.e., in the receiver 708 or the transmitter 704) more losses occur which may impact the load impedance. Although this may reduce end-to-end efficiency, power dissipation in the receiver may be reduced when the load impedance is not optimum. As power losses in the receiver 708 may impact the receiver's temperature, reducing the power losses in the receiver 708 may lessen the impact of the power losses on the receiver's temperature to allow the receiver 708 to help maintain its temperature below a threshold. While this may lower the end-to-end system efficiency, a constant an amount of power transferred may stay the same.

The load impedance of the coil pair may be a function of the DC voltage V_{rect} after a rectifier 720 at a fixed load power amount. The voltage V_{rect} may be adjusted by varying the drive voltage V_{D} of the driver circuit 724 in the transmitter 704. As the load impedance is a function of V_{rect}, and V_{rect} may be controlled by adjusting the drive voltage V_{D}, adjusting the drive voltage V_{D} may cause an adjustment of the load impedance of the system 700 such that Vₒᵤₜ is maintained constant. Adjusting the drive voltage V_{D} provides one mechanism for determining where losses between the transmitter 704 and receiver 708 in a wireless power transfer system 700 may occur.

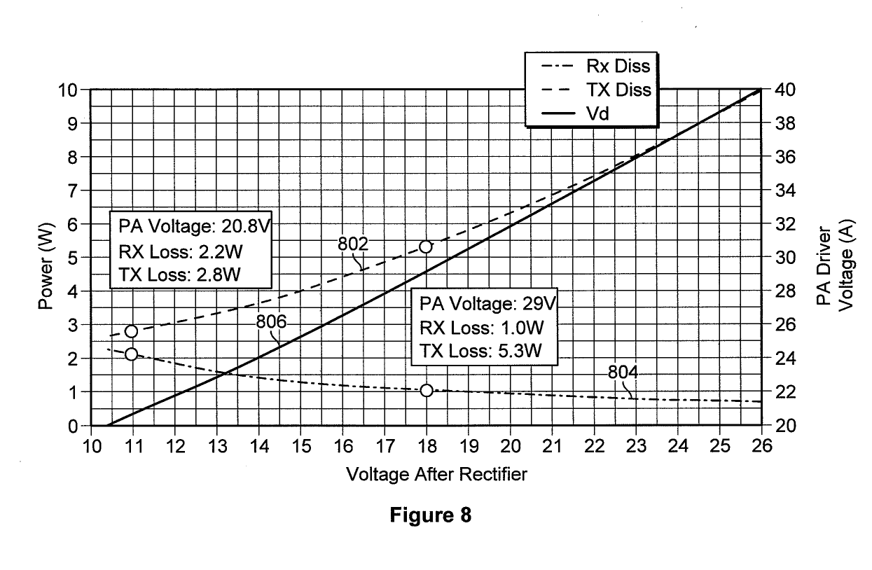

FIG. 8 is a plot showing transmitter 704 and receiver 708 power losses as a function of the voltage output by a rectifier 720 in the receiver 708. FIG. 8 further shows the relationship between the drive voltage V_{D} of the driver circuit 724 with the voltage V_{rect} at the output of the rectifier 720. FIG. 8 shows how the transmitter 704 and receiver 708 losses shown by the curves 802 and 804 are affected by changes in the drive voltage V_{D} (shown by the curve 806) of the driver circuit 724. As the drive voltage V_{D} increases (and correspondingly as V_{rect} increases), the transmitter power losses 802 in the transmitter 704 increase while the receiver power losses 804 in the receiver 708 decrease. Increasing transmitter power losses may decrease the efficiency of power transmission (which may be indicated by the power delivered to the receiver divided by the DC power into the transmitter). Reducing power losses in the receiver 708 helps to prevent the temperature of the receiver 708 from increasing. Reducing power losses in the receiver 708 increases the efficiency of receiving power (which may be indicated as the power delivered to the load divided by the power delivered to the receiver) and reduces dissipation in the receiver.

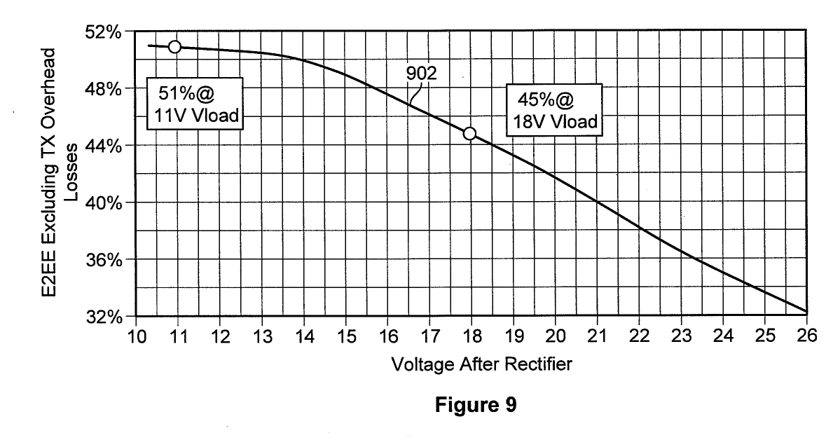

FIG. 9 is a plot showing the end-to-end efficiency of the wireless power transfer system 700 excluding transmitter 704 overhead losses as a function of the voltage output by a rectifier 720 in the receiver 708. As shown by FIG. 9, as the voltage V_{rect} output by the rectifier 720 increases (and correspondingly as the drive voltage V_{D} of the driver circuit 724 increases) the end-to-end efficiency decreases (shown by the curve 902). For example, when V_{rect} is 11 V, the efficiency is 51%. When V_{rect} is increased to 18 V, the efficiency drops to 45%.

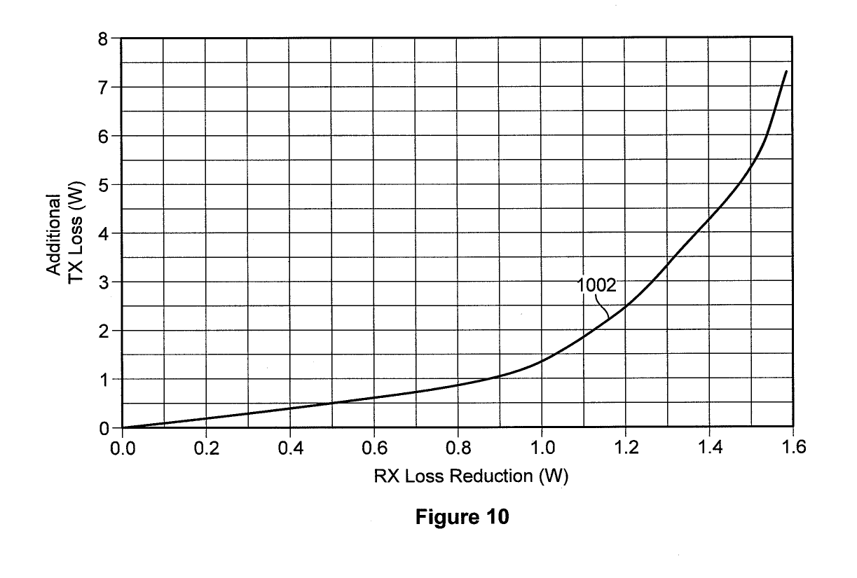

As voltages are controlled to adjust where losses in the system occur, reducing losses in the receiver 708, for example, results in increased losses in the transmitter 704. FIG. 10 is a plot showing the additional power loss in the transmitter 704 as a function of the power loss reduction in the receiver 708. As shown in FIG. 10, for a certain range of receiver power loss reduction (i.e., from 0 to about 1 W), the additional power losses in the transmitter increase gradually (shown by the curve 1002). However, reducing power losses in the receiver 708 after this range (i.e., from 1 W to 1.6 W) results in a steep increase in the additional power losses in the transmitter 404.

According to the results found as shown in FIGS. 8-10, exemplary embodiments are directed to designing a wireless power transfer system 700 so as to enable a wireless power receiver to be able to operate in thermally adverse conditions while maintaining reasonable charge times. This allows a receiver 708, such as a mobile phone, to avoid performing functions such as thermal cycling that may reduce charge times and that may require additional power. In one embodiment, the operating point at which the system operates may be adjusted in response to temperature increases in the receiver 708. In an exemplary embodiment, the operating point may correspond to a power transfer efficiency level and a power transfer level (or combination thereof) such that transmission losses dissipate within a thermal specification. In response to temperature increases in the receiver 708, power losses may be minimized in the receiver 708 (while sacrificing some end-to-end efficiency and increasing losses in the transmitter) in order to prevent the temperature of the receiver 708 from going above a threshold. While decreasing losses in the receiver 708 may have an adverse impact on end-to-end efficiency as shown in the FIGS. 8-10, the amount of power provided to the load may be maintained at a constant level in order to prevent degradation to charge times.

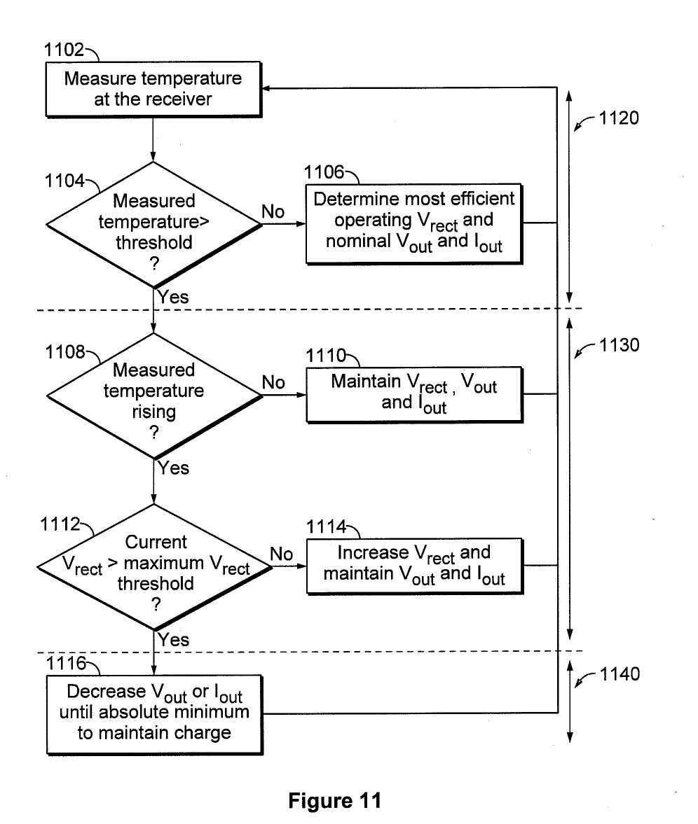

FIG. 11 is a flowchart showing an exemplary method for managing the temperature of a wireless power receiver 708, in accordance with exemplary embodiments of the invention. In block 1102, the receiver 708 measures its temperature using a temperature sensor 775. The temperature sensor 775 may be a thermistor located in a battery unit 756. In applications where it may be important to prevent functions such as thermal cycling of a battery, the temperature of the battery in the receiver 708 may be measured rather than a temperature of other portions of the receiver 708. The temperature value may be provided to temperature management circuitry 740 for processing or performing functions described in the blocks below. In some cases the receive controller 716 may perform the functions of temperature management circuitry 750.

In decision block 1104, the temperature management circuitry 740 compares the measured temperature value to a threshold. If the measured temperature value is below the threshold, then the temperature management circuitry 740 may determine the most efficient operating voltage V_{rect} (at the output of the rectifier 720) and nominal Vₒᵤₜ and Iₒᵤₜ (at the output of the DC-DC converter 722 for charging the battery) at the desired power as shown in block 1106. As described above, the actual adjustment of V_{rect} may be accomplished by adjusting the drive voltage V_{D} of the driver circuit 724. As such, the temperature management circuitry 750 may send a message via communication link 719 with information that the transmitter 704 may use to either increase or lower the drive voltage V_{d} of the driver circuit 724. The transmitter 704 may receive the information at temperature management circuitry 730 for processing. In some cases the transmit controller 715 may perform the functions of the temperature management circuitry 730. The blocks 1102-1106 correspond to an operating point region 1102 corresponding to temperature conditions where the system can adjust V_{rect}, Vₒᵤₜ and Iₒᵤₜ, to deliver the desired power level at maximum efficiency.

If the temperature management circuitry 750 determines that the temperature of the receiver 708 is above the threshold in block 1104, then the temperature management circuitry 740 may cause the receiver 708 to enter into a reduced end-to-end efficiency mode as shown in the region 1130. In this case, in decision block 1108, the temperature management circuitry 740 determines whether the temperature is rising by comparing the measured temperature value to past temperature measurements. If the temperature is not rising, then V_{rect}, Vₒᵤₜ, and Iₒᵤₜ are maintained at current levels at the existing efficiency level as shown in block 1110. These levels may correspond to a reduced end-to-end efficiency level, however, charge times may be maintained substantially constant.

If temperature management circuitry 750 determines the temperature is rising (block 1108), then the temperature management circuitry 750 determines whether the current V_{rect} is above an maximum threshold as shown in decision block 1112. If the current V_{rect} is below the maximum threshold, then the temperature management circuitry 750 may cause V_{rect} to be increased while Vₒᵤₜ and Iₒᵤₜ are maintained at their current values. As described above, in one embodiment, V_{rect} may be adjusted by adjusting the drive voltage V_{D} of the driver circuit 724 in the transmitter 704 as shown in block 1114. As such, temperature management circuitry 750 via communication circuitry 742 may send a message via the communication link 719 with a command to adjust the drive voltage V_{D} by a certain amount. In some embodiments, the transmitter 704 may receive an indication that temperature is rising and determine the amount to adjust the drive voltage V_{D}. Increasing V_{rect} may result in reducing losses (and heat dissipation) in the receiver 708. While this may reduce end-to-end efficiency, reducing power losses in the receiver may prevent the temperature from rising further. Furthermore, as Vₒᵤₜ and Iₒᵤₜ are maintained at current levels, a constant power level may be provided to charge the battery unit 756 such that charging time may be maintained substantially constant.

If temperature management circuitry 750 determines that the current V_{rect} is above the maximum threshold in block decision 1112, then in block 1116, either Vₒᵤₜ or Iₒᵤₜ is decreased until they reach minimum values for maintaining a charge. This may correspond to an operating point region 1140 where both end-to-end efficiency and power provided to the load are reduced. As such, in this case, both end-to-end efficiency and the amount of power delivered to a battery unit 750 may be reduced. The impact on the charge time for the receiver 608 will depend on the reduction required in Vₒᵤₜ or Iₒᵤₜ to prevent the temperature of the receiver 708 from increasing above a threshold. As temperature falls either due to reduced power from the DC-DC converter 722 or other operating conditions, Vₒᵤₜ and Iₒᵤₜ may be increased until the temperature falls below a threshold. In some cases, the maximum V_{rect} threshold may correspond to the point as shown in FIG. 10 where receiver power loss reductions result in a steep increase in transmitter loss reductions. The maximum V_{rect} threshold may further correspond to some lower bound acceptable efficiency level.

Accordingly, by adjusting the voltage V_{rect} through adjusting the drive voltage V_{D} of the driver circuit 724 at the transmitter 704 in response rising temperatures at the receiver 708, power losses may shifted to a transmitter 704 to prevent overheating of the receiver. While this may result in reduced end-to-end efficiency, by maintaining Vₒᵤₜ, there is minimal impact on the charge time as a constant output power may be maintained for a range of V_{rect} values.

Accordingly, and in accordance with the method described in FIG. 11, one embodiment provides for a wireless power transmitter 704. The transmitter 704 includes a transmit coil 714 that is configured to wirelessly transmit power to a wireless power receiver 708. The transmitter 704 may include communication circuitry 732 that receives information based on a temperature measurement of a receiver 704. For example, the information may be a message indicating whether to increase or decrease the drive voltage V_{D} of the driver circuit 724. In some embodiments, the temperature measurement data may be received by the communication circuitry 732 of the transmitter 704 for processing to allow the temperature management circuitry 730 of the transmitter 704 to make adjustments. The transmitter 704 further includes a transmit controller circuit 715 that is configured to adjust an operating point based on the information about the receiver's temperature. Adjusting the operating point may correspond to adjusting the efficiency, the level of power transferred, or a combination thereof.

In some embodiments, the operating point may correspond to adjusting the efficiency of wireless power transmission such that power losses are reduced in the receiver 708 to help reduce the impact of power losses on the temperature of the receiver 708. This may correspond to increasing the receiver's efficiency. Even if end-to-end efficiency is decreased, the receiver 708 may maintain the amount of power delivered to the load constant. In some embodiments, the transmit controller circuit 715 may be configured to adjust the operating point by adjusting a drive voltage V_{D} level of the driver circuit 724. As described above the driver circuit 724 may be a switching amplifier that is configured to receive a square wave input and output a sinusoidal signal (i.e., AC signal) to be provided to the transmit coil 714 for outputting power.

As stated, adjusting the drive voltage level may correspond to increasing the voltage after the rectifier 720 V_{rect}. As described above with reference to FIG. 11, if the temperature of the receiver 708 is rising, the transmit controller circuit 715 may increase the drive voltage V_{D} level of the driver circuit 724. While decreasing the efficiency at the transmitter, efficiency may be increased at the receiver to reduce heat dissipation. This may reduce end-to-end efficiency, but may help avoid overheating in the receiver 708.

It is noted that the transmitter 704 may further be configured to take other actions or perform other functions that result in decreasing losses in the receiver while maintaining a constant power output. For example, the transmitter 704 may perform other functions to increase the receiver's efficiency other than increasing the drive voltage V_{D} level of the driver circuit 724.

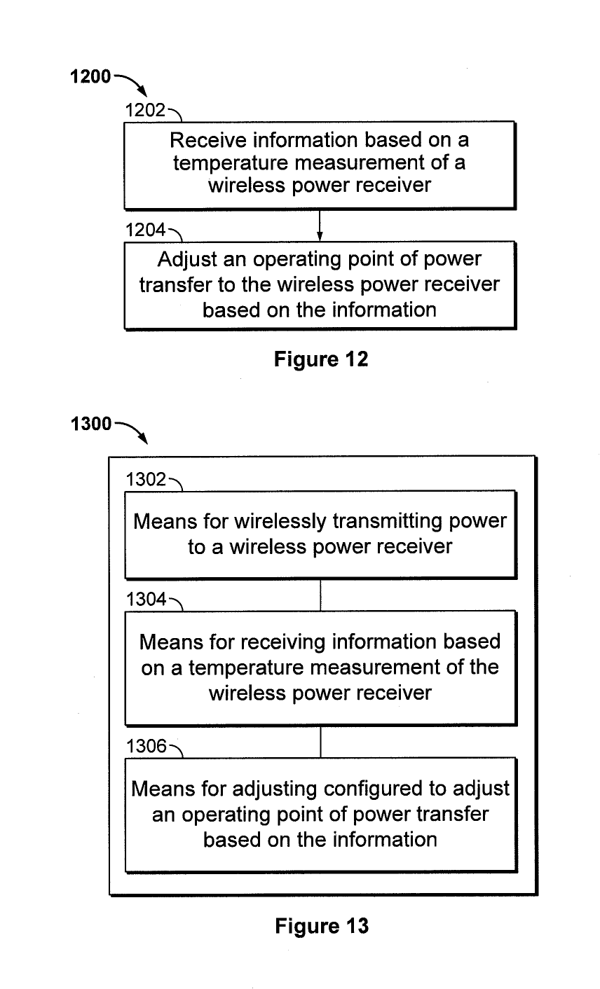

FIG. 12 is a flow chart of an exemplary method 1200 for managing a temperature level of a wireless power receiver 708, in accordance with exemplary embodiments of the invention. In one embodiment, the method 1200 may be performed by a wireless power transmitter 704. In block 1202, a transmitter 704 providing power wirelessly to a wireless power receiver 708 may receive information based on a temperature measurement of a wireless power receiver 708. As described above, the information may correspond to a temperature value or other indications or instructions corresponding to the actions the transmitter might take in response to temperature changes in the receiver (e.g., increasing or decreasing the drive voltage V_{D} level of an driver circuit 724). Based on the information, in block 1204, the transmitter 704 may be configured to adjust an operating point of power transfer to the wireless power receiver 708. As described above, adjusting the operating point may correspond to adjusting system efficiency to reduce power losses in the receiver by, for example, increasing the drive voltage V_{D} level of an driver circuit 724 by a determined amount.

FIG. 13 is a functional block diagram of a wireless power transmitter 1300, in accordance with an exemplary embodiment of the invention. Wireless power transmitter 1300 comprises means 1302, 1304, and 1306 for the various actions discussed with respect to FIGS. 1-12.

In accordance with the method described above with reference to FIG. 11, another embodiment provides for a wireless power receiver 708. The receiver 708 includes a receive coil 718 that is configured to wirelessly receive power from a wireless power transmitter 704. The receiver 708 may further include a battery unit 756 comprising a temperature sensor 775 such as a thermistor. The receiver 708 may include a receive controller circuit 716 configured to measure a temperature of the battery unit 756 (i.e., the receive controller circuit 716 may receive and derive temperature data from the temperature sensor 775 output). The receive controller circuit 716 may further be configured to adjust an operating point to maintain the temperature below the threshold while maintain charge times substantially constant. It is noted that the temperature of other portions of the receiver 708 rather than the battery unit 756 may be measured and controlled in accordance with the principles described herein. In one aspect, managing the temperature of the battery unit 756 may be done to prevent a device 750 from performing functions such as thermal cycling.

In some embodiments, the receiver 708 may include communication circuitry 742 that may be configured to send information based on the temperature measurement to a wireless power transmitter 704 to adjust the operating point. For example, the communication circuitry 742 may be configured to send a message indicating whether to increase or decrease the drive voltage V_{D} of the driver circuit 724. In some embodiments, the temperature measurement data may be sent to the transmitter 704 to allow the temperature management circuitry 730 to determine operating point adjustments. While adjusting an operating point, the amount of power being provided to the battery unit 750 may be maintained substantially constant. This may be accomplished by controlling the voltage output Vₒᵤₜ and current output Iₒᵤₜ of the DC-DC converter 722 to be maintained constant as the input to the DC-DC converter V_{rect} changes in response to the operating point adjustment. This may allow for maintaining charge times while also reducing power losses in the receiver 708 for managing the temperature of the receiver 708.

As described above, in some embodiments, the receiver includes a rectifier circuit 720 configured to convert a signal received from the receive coil 718 into a DC signal that may be used to charge the battery unit 756. To adjust the operating point, the receive controller 716 may be configured to cause an increase in the voltage output by the rectifier if temperature of the battery unit 756 is rising. Causing an increase in V_{rect} may correspond to increasing the receiver's efficiency and reducing heat dissipation in the receiver 708 while maintaining the amount of power provided to a load constant. In one embodiment, increasing V_{rect} may be performed by sending a message to the transmitter 704 to increase the drive voltage V_{D} of the driver circuit 724. It should be appreciated that other methods may be used by the receiver 708 to reduce losses to prevent while maintaining an amount of power receiver are contemplated and may be applied in accordance with principles described herein.

As described above, in some embodiments, adjusting the operating point may correspond to adjusting the end-to-end efficiency of wireless power transfer while maintaining a constant level of power provided to a load such that power losses are reduced in the receiver 708 to help reduce the impact of power losses on the receiver's temperature. In some embodiments, the operating point may correspond to both adjusting efficiency and power transferred or a combination thereof. As described above with reference to FIG. 11, if the temperature of the receiver 708 is rising, the receiver 708 may send a message to cause the transmit controller circuit 715 to increase the drive voltage V_{D} level of the driver circuit. This may reduce end-to-end efficiency, but may help avoid overheating in the receiver as efficiency in the receiver may be increased. Moreover, as described above with reference to FIG. 11, the receiver 708 may be configured to lower an amount of power provided to the battery unit 750 if the receiver controller 716 determines that the temperature is above a temperature threshold (e.g., by adjusting Vₒᵤₜ or Iₒᵤₜ). In some cases, this temperature threshold may correspond to an efficiency threshold as the end-to-end efficiency may not be lowered below a certain point when reducing power losses in the receiver. Decreasing an amount of power provided to the battery unit 750 may be performed only in extreme situations to prevent excessively high temperatures in the receiver 708.

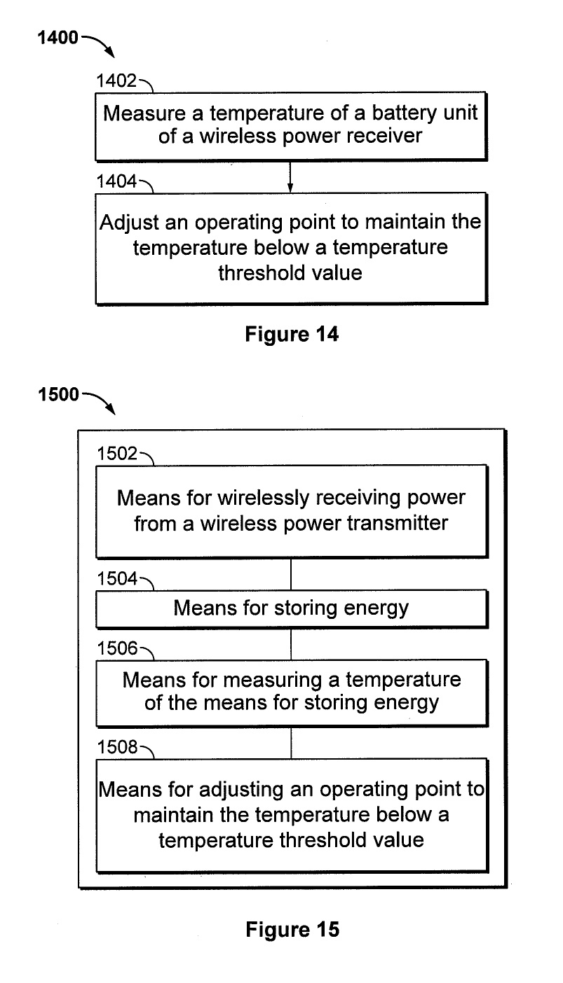

FIG. 14 is a flow chart of an exemplary method 1400 for managing a temperature level of a wireless power receiver, in accordance with exemplary embodiments of the invention. In one embodiment, the method may be performed by a wireless power receiver 708. In block 1402, a wireless power receiver 708 may measure a temperature of a battery unit of the wireless power receiver 708. In block 1404, the wireless power receiver 708 may adjust an operating point from a wireless power transmitter to maintain the temperature below a temperature threshold value. As described above, adjusting the operating point may correspond to adjusting efficiency (e.g., end-to-end efficiency) by, for example, sending a message to the transmitter 404 to increase the drive voltage V_{D} level of an driver circuit 724 such that a voltage level output of a rectifier circuit 720 is increased. This may lower power losses in the receiver 708. In this case, the amount of power (e.g., controlled by Vₒᵤₜ and Iₒᵤₜ) provided to a battery unit 750 may be maintained constant to prevent degradation of charge times.

FIG. 15 is a functional block diagram of a wireless power receiver 1500, in accordance with an exemplary embodiment of the invention. Wireless power receiver 1500 comprises means 1502, 1504, 1506, and 1508 for the various actions discussed with respect to FIGS. 1-14.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer readable medium. Computer readable media includes both computer storage media and communication media including any medium that facilitates transfer of a computer program from one place to another. A storage media may be any available media that may be accessed by a computer. By way of example, and not limitation, such computer readable media may comprise RAM, ROM, EEPROM, CD ROM or other optical disk storage, magnetic disk storage or other magnetic storage devices, or any other medium that may be used to carry or store desired program code in the form of instructions or data structures and that may be accessed by a computer. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A wireless power transmitter, comprising:
a transmit circuit comprising a transmit coil, the transmit circuit configured to wirelessly transmit power to a wireless power receiver;
a communication circuit configured to receive information based on a temperature measurement of the wireless power receiver; and
a transmit controller circuit configured to adjust an operating point of power transfer based on the information.

2. The transmitter of claim 1, wherein the transmit controller circuit is configured to adjust the operating point to adjust an efficiency level of power transmission.

3. The transmitter of claim 2, wherein the transmit controller circuit is configured to raise or lower the efficiency level of power transmission.

4. The transmitter of claim 3, wherein the transmit controller circuit is configured to lower the efficiency level of power transmission to reduce power losses in the wireless power receiver.

5. The transmitter of claim 1, further comprising a driver circuit configured to provide a signal to the transmit circuit, wherein the transmit controller circuit is configured to adjust the operating point by adjusting a drive voltage level of the driver circuit.

6. The transmitter of claim 5, wherein the information indicates that the temperature of the wireless power receiver is rising, and wherein the transmit controller circuit is configured to increase the drive voltage level of the driver circuit in response to the information.

7. The transmitter of claim 1, wherein the transmit controller circuit is configured to adjust the operating point so as to increase an efficiency level of the wireless power receiver.

8. The transmitter of claim 7, further comprising a driver circuit configured to provide a signal to the transmit circuit, wherein an the efficiency level of the wireless power receiver is increased by increasing a drive voltage level of the driver circuit.

9. A method for managing a temperature level of a wireless power receiver, the method comprising:
receiving information based on a temperature measurement of the wireless power receiver; and
adjusting an operating point of power transfer based on the information.

10. The method of claim 9, wherein adjusting an operating point comprises adjusting an efficiency level of power transfer.

11. The method of claim 10, wherein adjusting the efficiency level comprises raising or lowering the efficiency level of power transmission.

12. The method of claim 11, wherein adjusting the efficiency level comprises lowering the efficiency level of power transmission to reduce power losses in the wireless power receiver.

13. The method of claim 9, wherein adjusting the operating point comprises adjusting a drive voltage level of a driver circuit configured to provide a signal to a transmit circuit to wirelessly output power.

14. The method of claim 13, wherein the information indicates that the temperature of the wireless power receiver is rising, and wherein adjusting the drive voltage level comprises increasing the drive voltage level of the driver circuit in response to the information.

15. The method of claim 9, wherein adjusting the operating point comprises adjusting the operating point so as to increase an efficiency level of the wireless power receiver.

16. The method of claim 15, wherein adjusting the operating point comprises increasing a drive voltage level of a driver circuit configured to drive a transmit circuit to wirelessly output power.

17. A wireless power transmitter, comprising:
means for wirelessly transmitting power to a wireless power receiver;
means for receiving information based on a temperature measurement of the wireless power receiver; and
means for adjusting configured to adjust an operating point of power transfer based on the information.

18. The transmitter of claim 17, wherein the means for adjusting is configured to adjust the operating point to adjust an efficiency level of power transmission.

19. The transmitter of claim 18, wherein the means for adjusting is configured to raise or lower the efficiency level of power transmission.

20. The transmitter of claim 19, wherein the means for adjusting an operating point is configured to lower the efficiency level of power transmission to reduce power losses in the wireless power receiver.

21. The transmitter of claim 17, further comprising means for driving a signal configured to provide a signal to the means for wirelessly transmitting power, wherein the means for adjusting an operating point is configured to adjust the operating point by adjusting a drive voltage level of the means for driving a signal.

22. The transmitter of claim 21, wherein the information indicates that the temperature of the means for wirelessly receiving power is rising, and wherein the means for adjusting an operating point is configured to increase the drive voltage level of the means for driving in response to the information.

23. The transmitter of claim 17, wherein the means for adjusting is configured to adjust the operating point so as to increase an efficiency level of the wireless power receiver.

24. The transmitter of claim 23, further comprising means for driving configured to provide a signal to the means for wirelessly transmitting power, wherein an efficiency level of the wireless power receiver is increased by increasing a drive voltage level of the means for driving.

25. The transmitter of claim 17, wherein the means for means for wirelessly transmitting power comprises a transmit circuit, wherein the means for receiving comprises a communication circuit, and wherein the means for adjusting comprises a transmit controller circuit.

26. The transmitter of claim 21, wherein the means for driving comprises a driver circuit.

27. A wireless power receiver, comprising:
a receive circuit comprising a receive coil, the receive circuit configured to receive wireless power from a wireless power transmitter;
a battery unit; and
a receive controller circuit configured to measure a temperature of the battery unit, the receive controller circuit being further configured to cause an adjustment in an operating point to maintain the temperature below a temperature threshold value.

28. The wireless power receiver of claim 27, wherein the operating point is configured to be adjusted so as to adjust an efficiency level of power transfer.

29. The wireless power receiver of claim 28, wherein the efficiency level of power transfer is lowered at the wireless power transmitter so as to reduce power losses in the wireless power receiver.

30. The wireless power receiver of claim 27, wherein the receive controller circuit is configured to maintain an amount of power delivered to the battery unit to be substantially constant when the operating point is adjusted.

31. The wireless power receiver of claim 27, wherein the receive controller circuit is configured to cause an adjustment in the operating point by sending a message based on the temperature to the wireless power transmitter.

32. The wireless power receiver of claim 27, further comprising a rectifier circuit configured to convert a signal received from the receive circuit into a DC signal, wherein the receive controller circuit is configured to cause an increase in a voltage output by the rectifier circuit if the temperature of the battery unit is rising.

33. The wireless power receiver of claim 27, wherein the receive controller circuit is configured to adjust the operating point so as to increase an efficiency level of the wireless power receiver.

34. The wireless power receiver of claim 33, further comprising a rectifier circuit configured to convert a signal received from the receive circuit into a DC signal, wherein the receive controller circuit is configured to increase an efficiency level of the wireless power receiver by causing an increase in the voltage output by the rectifier circuit.

35. The wireless power receiver of claim 27, wherein the receive controller is configured to reduce an amount of power delivered to the battery unit if the temperature is above a threshold.

36. A method for managing a temperature level of a wireless power receiver, the method comprising:
measuring a temperature of a battery unit of the wireless power receiver; and
adjusting an operating point to maintain the temperature below a temperature threshold value.

37. The method of claim 36, wherein adjusting the operating point adjusts an efficiency level of power transfer.

38. The method of claim 37, wherein adjusting the efficiency level comprises causing a transmit efficiency level to be lowered to reduce power losses in the wireless power receiver.

39. The method of claim 36, further comprising maintaining an amount of power delivered to the battery unit substantially constant when the operating point is adjusted.

40. The method of claim 36, wherein adjusting the operating point comprises sending a message based on the temperature to a wireless power transmitter transmitting power to the wireless power receiver.

41. The method of claim 36, wherein adjusting the operating point comprises causing an increase in a voltage output by a rectifier circuit of the wireless power receiver if the temperature of the battery unit is rising.

42. The method of claim 36, wherein adjusting the operating point comprises adjusting so as to increase an efficiency level of the wireless power receiver.

43. The method of claim 42, wherein adjusting comprises causing an increase in a voltage output by a rectifier circuit of the wireless power receiver.

44. The method of claim 36, further comprising lowering an amount of power delivered to the battery unit if an efficiency level of power transfer is below an efficiency threshold.

45. A wireless power receiver, comprising:
means for wirelessly receiving power from a wireless power transmitter;
means for storing energy;
means for measuring a temperature of the means for storing energy; and
means for adjusting an operating point to maintain the temperature below a temperature threshold value.

46. The wireless power receiver of claim 45, wherein the operating point is adjusted so as to adjust an efficiency level of power transfer.

47. The wireless power receiver of claim 46, wherein the means for adjusting an operating point is configured to cause a transmit efficiency level to be lowered to reduce power losses in the wireless power receiver.

48. The wireless power receiver of claim 45, further comprising means for maintaining an amount of power delivered to the battery unit to be substantially constant when the operating point is adjusted.

49. The wireless power receiver of claim 45, wherein the means for adjusting an operating point is configured to adjust an operating point by sending a message based on the temperature to the wireless power transmitter.

50. The wireless power receiver of claim 45, further comprising means for rectifying configured to convert a signal received from the means for wirelessly receiving power into a DC signal, wherein the means for adjusting an operating point is configured to cause an increase in a voltage output by the means for rectifying if the temperature of the means for storing energy is rising.

51. The wireless power receiver of claim 45, wherein the means for adjusting an operating point is configured to adjust the operating point so as to increase an efficiency level of the means for wirelessly receiving power.

52. The wireless power receiver of claim 51, further comprising means for rectifying configured to convert a signal received from the means for wirelessly receiving power into a DC signal, wherein the means for adjusting an operating point is configured to increase an efficiency level by causing an increase in the voltage output by the means for rectifying.

53. The wireless power receiver of claim 45, wherein the means for adjusting an operating point is configured to lower an amount of power delivered to the battery unit if an efficiency level of power transfer is below an efficiency threshold.

54. The wireless power receiver of claim 45, wherein the means for wirelessly receiving power comprises a receive circuit, wherein the means for storing energy comprises a battery unit, and wherein the means for measuring and the means for adjusting comprises a receive controller circuit.

55. The wireless power receiver of claim 48, wherein the means for maintaining an amount of power comprises a receive controller circuit.

56. The wireless power receiver of claim 50, wherein the means for rectifying comprises a rectifier circuit.
